(19) United States
(12) Patent Application Publication
(10) Pub. No.: US 2016/0243452 A1
(43) Pub. Date: Aug. 25, 2016

(54) AUDIO FREQUENCY RESPONSIVE INTERACTIVE SYSTEM AND METHOD

(71) Applicant: Edo Segal, New York, NY (US)

(72) Inventor: Edo Segal, New York, NY (US)

(21) Appl. No.: 15/044,857

(22) Filed: Feb. 16, 2016

Related U.S. Application Data
(60) Provisional application No. 62/116,309, filed on Feb. 13, 2015.

(51) Int. Cl. A63H 3/28; G06K 19/07; A63H 30/04; H04W 4/00

(52) U.S. Cl. CPC A63H 3/28; H04W 4/008; G06K 19/0716; A63H 30/04

(57) ABSTRACT

An interactive apparatus is disclosed for providing actuations in at least one point of the apparatus. An audio player component is provided that is configured to receive and play an audio file having a plurality of frequencies. Further, an audio detection component is included that is configured to detect at least one frequency as the audio file plays. At least one solenoid component is included that is configured to actuate at least one point in the object portion in response to the at least one audio detection component detecting the at least one frequency.

### CROSS-REFERENCE TO RELATED PATENT APPLICATIONS

This application is based on and claims priority to U.S. Provisional Patent Application 62/116,309, filed Feb. 13, 2015, the entire contents of which is incorporated by reference herein as if expressly set forth in its respective entirety herein. The present application further incorporates by reference U.S. Pat. No. 8,955,750, issued Feb. 17, 2015, in its entirety as if expressly set forth herein.

### FIELD

The present application relates, generally, to systems and methods associated with interactive models.

### BACKGROUND

The increasing proliferation of mobile computing devices, such as smartphones, has resulted in users increasingly relying on such devices for recreational purposes, including for game playing. Accordingly, many electronic video games such as multi-player video games have overtaken traditional “physical” games, such as board games, in popularity. While electronic video games may provide many advantages over board games, such video games do not provide the same tangible, ‘real world’ gameplay experience, as reflected in certain board games through the use of figurines or gameplay pieces.

### SUMMARY

An interactive apparatus is disclosed for providing actuations in at least one point of the apparatus. An audio player component is provided that is configured to receive and play an audio file having a plurality of frequencies. Further, an audio detection component is included that is configured to detect at least one frequency as the audio file plays. At least one solenoid component is included that is configured to actuate at least one point in the object portion in response to the at least one audio detection component detecting the at least one frequency.

These and other aspects, features and advantages can be appreciated from the accompanying description of certain implementations and the accompanying figures and claims.

### BRIEF DESCRIPTION OF THE DRAWINGS

Aspects of the present disclosure will be more readily appreciated upon review of the detailed description of its various embodiments, described below, when taken in conjunction with the accompanying drawings, of which:

FIG. 1 illustrates an electronic base, in accordance with an example implementation of the present application;

FIG. 2 is a diagram illustrating a skeleton design of a model in connection with an example implementation of the present application;

FIG. 3 is a diagram illustrating an example portion of a head assembly, in accordance with an example implementation;

FIGS. 4A-4B are diagrams illustrating an inner skeleton that include elements in the head, in accordance with an example implementation;

FIG. 5 is a diagram illustrating an example head assembly that includes magnetic elements that are placed horizontally in the head;

FIG. 6 is an example component associated with recording movements, in accordance with an example implementation of the present application;

FIG. 7 is a diagram illustrating a scheme for recording hand movements of a puppeteer in connection with the model set forth in an example implementation;

FIG. 8 is a diagram illustrating example power key choices for control of the solenoids, in connection with an example implementation;

FIG. 9 is an example schematic of a circuit board for detecting data clusters in a general channel and for identifying data type for transfer, in accordance with an example implementation of the present application;

FIG. 10 is an diagram that illustrates a model, in connection with an example implementation;

FIGS. 11A-11B are diagrams illustrating example Bluetooth in accordance with implementations of the present application;

FIG. 12 is a diagram illustrating an example solenoid usable in connection with an example implementation of the present application;

FIGS. 13A and 13B are diagrams illustrating an example model in various states;

FIG. 14 is a diagram illustrating an implementation in which a model is a responsive to audio and social/developmental assistance with a child to brush teeth; and

FIG. 15 is a flow diagram showing a routine that illustrates a broad aspect of a method for processing code(s) in accordance with at least one implementation disclosed herein.

### DESCRIPTION

The referenced systems and methods are described herein with reference to the accompanying drawings, in which like reference numerals refer to like elements and in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods.

The present application provides an interactive model that is operable in a network, can operate in an “always-on” mode, and that carries a very low cost of manufacture. In one or more implementations of the present application, the model includes a wireless speaker and microphone (e.g., Bluetooth-enabled speaker and microphone), and can include an animatronic structure and memory (e.g., flash memory). Information directed to kinetics can be encoded in audio, such as by playing a sound file (e.g., .WAV, .MP3, .AIFF, .DCT or other suitable format) that includes frequencies that, when detected by the model, cause its movable parts (e.g., levers and hinges) to actuate.

In one or more implementations, a computing device, such as a smart phone, tablet or other mobile computing device, executes an application (e.g., a mobile app) or other software. The mobile app can provide instructions for audio to play from the speaker configured with the model, which can result in one or more components of the model to actuate in response. The model can further be configured with a series of low-cost sensors that detect the proximity of physical objects, including objects configured with passive radio-frequency identification (“RFID”) tags. The model can further be configured with one or more components to send and receive information associated therewith to and from mobile computing device.

In one or more implementations, one or more objects external to the model can be configured with passive RFID tags, and the model can be configured with components for passive RFID reading functionality. In another implementation, one or more objects may be configured with a Bluetooth beacon or other suitable component(s) that can be detected by components configured with the model. Moreover, the present patent application enables wireless tethering of the networked mobile computing device (e.g., smartphone) and the model thereby enabling updates of content, such as related to the time of day, date, weather, or virtually any other information for interactivity, to be used in connection with the present application. Moreover, the model can be configured with memory to store information, such as for interactivity, prior to or in lieu of transmission of information to and/or from a mobile computing device.

Accordingly, a model that is configured with an audio output component, such as an internal Bluetooth speaker, an audio input component, such as a microphone, and detection functionality, such as passive RFID reading functionality, can interact with a user including as a function of data and/or sound transmissions to and/or from a mobile computing device. In one non-limiting example implementation, simple commands can be formatted in the form of respective frequencies, which resulted in movement, such as via one or more potentiometers, resulting in actuation of one or more components in the model.

The model, which can be configured as a doll or other figurine, can be physically accessible and appear to have “Listen and Respond” functionality. Audio input such as from a microphone, audio output, such as from a Bluetooth-enabled speaker, and kinetics such as from a responsive animatronic framework, enable the model to appear to respond to specific verbal cues and even to converse with users. Moreover, by communicating with a smart device via Bluetooth Low Energy, new content can be passively pushed and stored to the model. Even when within a significant range, such as 30 to 50 feet (or more) of the computing device, the model can become highly interactive and offer contextual activity, including by responding to audio cues (voice, broadcast, etc.) and time of day. While the model is not in contact with a computing device (e.g., a smart phone), the model may exhibit a smaller yet still smart range of behaviors.

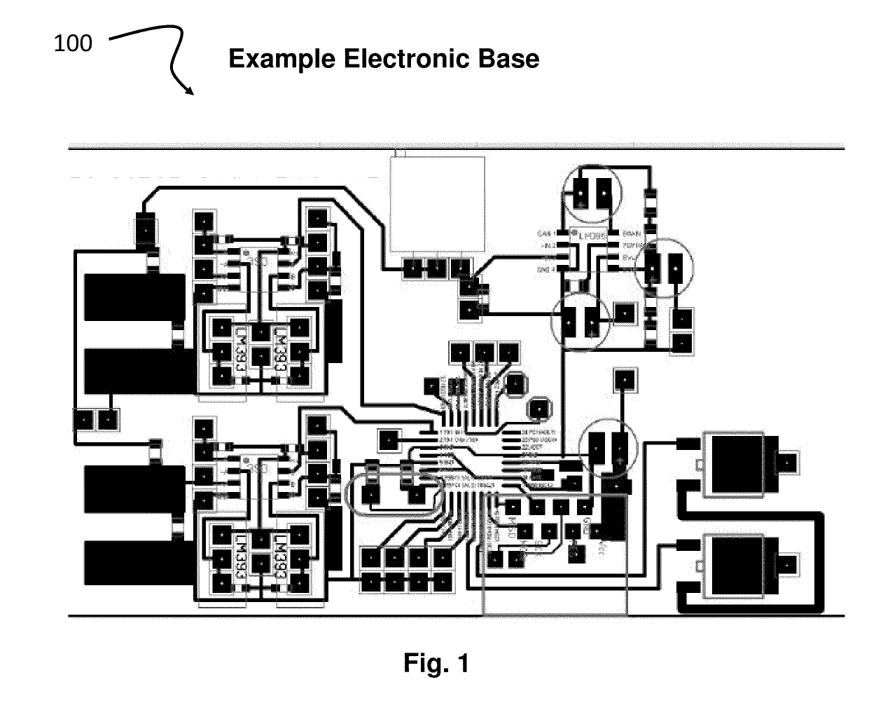

An example electronic base 100 in accordance with an example implementation for a model is illustrated in FIG. 1.

In one or more implementations, a cross-platform application (e.g., a mobile app) experience can deliver automatic content to the model, as well as also gives users an ability to control the experience of other users of the model (e.g., their children's experience). For example and in an implementation, the model can be configured with a communication module that enables. As new content is downloaded to the app via Wi-Fi, cellular or other communications channel, and when in the vicinity of an app-equipped smart device, the model can listen to broadcast content, e.g., storybooks, and respond appropriately.

In various applications, the present application includes a model that can be configured to be cross-generational and a cultural touchstone, with potential to be one of the most meaningful consumer products to date. Much more than a simple dancing plaything, a model configured in accordance with the teachings herein provides a networked, “always-on” companion and a powerful vehicle for receiving and delivering daily programming. Furthermore, the model can cost less to manufacture than a traditional animatronic model.

In operation, the present application includes a model that can listen and converse meaningfully, such as with a child. Beyond simply dancing, laughing and singing in pre-programmed ways, the model in accordance with the present application is capable of evolving and can learn a seemingly limitless number of behaviors. The model can, accordingly, be used to reinforce new habits based on both a user's life-stage and external content (e.g., the time of day). In an implementation as a child's toy, the model can be programmed by parents to deliver appropriate educational content and that can be updated daily with new lessons and interactive content.

For both the user of the model (e.g., a child, student or other entity) and a user of the mobile computing device (e.g., a parent, teacher or other entity), the present application provides a seemingly magical experience, almost as if the model were a fully aware, alive entity that is interacting. The model can appear to know the time of day, to listen and respond to conversational cues, and can engage in contextually relevant activities. Spoken words can be provided, such as via the Bluetooth speaker, and a corresponding mechanical elements (such as a jaw) can actuate in response.

Further, and in connection with an example implementation in which an object include shoes that are configured with an RFID tag, the model can appear to ask a child to put on shoes so the model can go outside with the user. The user can be prompted to find the RFID-equipped shoes, and once the shoes are placed on the model's feet, the model can respond positively. Further in this non-limiting example implementation, the model can prompt a child to bring the model along and they will look for shoes together. Using iBeacon or other functionality, the model can say “warmer,” “hot,” “very hot,” “cold” or “colder” depending on the child's proximity to the shoes.

In another non-limiting example, a simple listening experience in which the model chimes in as a user reads from a book. The model can interject at various points, such as to offer additional commentary while the user reads. By detecting input from the user, the model can cease adding commentary or add more, accordingly.

Thus, the present application provides a cross-platform real-world application experience that not only delivers automatic content to an interactive model, but also provides for dynamic responsiveness. Such responsiveness can be useful in many contexts, such as during long travel (car-trip- or airplane-appropriate content and interactions to educate and entertain children during long travel experiences, photo hunt “I Spy” games, spot objects of certain colors, play an alphabet game, or the like).

In accordance with an example physical model, an inner skeleton can be provided that supports a spine (e.g., its back) and provide rigidity for the workings of various mechanical parts included in the model's mouth and neck. The model's mouth can open to convey a character's personality and to be recognizable. The electronics assist with control of various parts of the model, such as hands, mouth, legs, or the like. The electronics can one or more low cost integrated circuits, which can translate commands to actuate the coils. include Bluetooth connectivity provided with a smartphone or other mobile computing device. Further, indication and transmission of audio sounds to the smartphone can be provided, as a data coding algorithm that controls various parts of the model.

For example, when the model is activated (is turned on), the model can greet with a hello. Sounds can cause parts of the model to actuate, such as mouth opening and closing, lips can move in sequence or simultaneously. When the model's battery is running low, the model can say: “Hey, my battery is low, please charge me.” When the model is turned off, the model can recite, “Bye-bye, see you later.” These examples provide an indication of functionality in accordance with the present application.

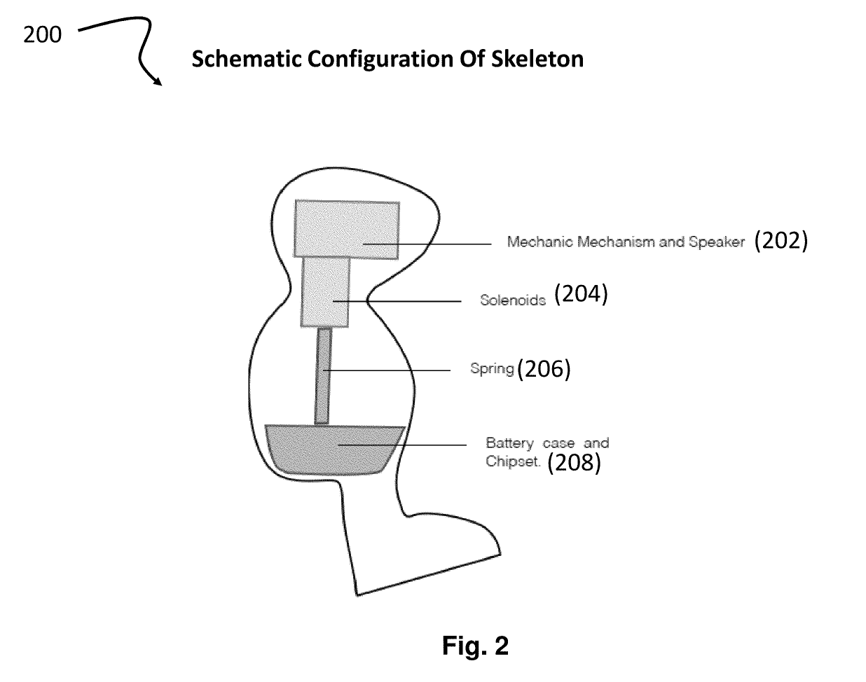

FIG. 2 is a simple diagram illustrating an example skeleton design 200 of a model in connection with an example implementation of the present application. An example height of the model is about 35 cm. In the implementation shown in FIG. 2, the head unit is configured to contain a speaker and one or more mechanical parts 202. Further, solenoids 204, which may provide magnetic fields, are placed upright and closer to each other in the neck. A spring portion 206 is coupled between solenoids 204 and a battery case and chipset 208. When attached to the base 100, for example, the springs actuate respective animation points of the model skeleton 200, independently and/or concurrently.

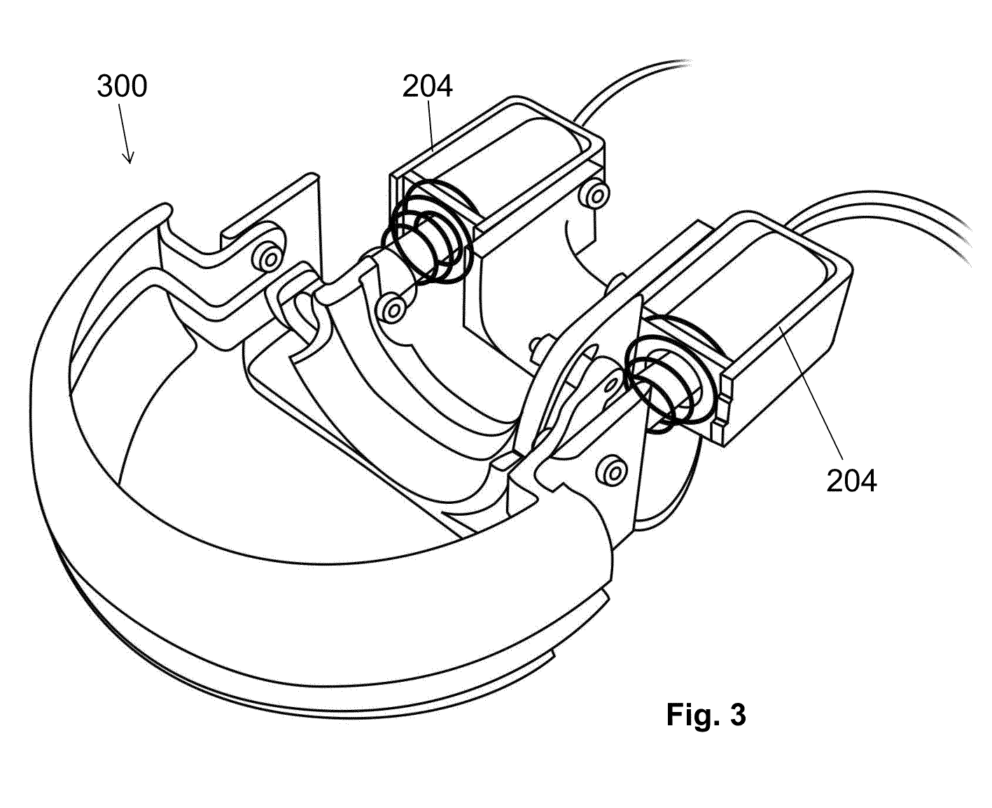

FIG. 3 is a simple diagram illustrating an example portion of a head assembly 300 in accordance with an example implementation of a model. The head assembly 300 can include solenoids 204 in or near the neck area.

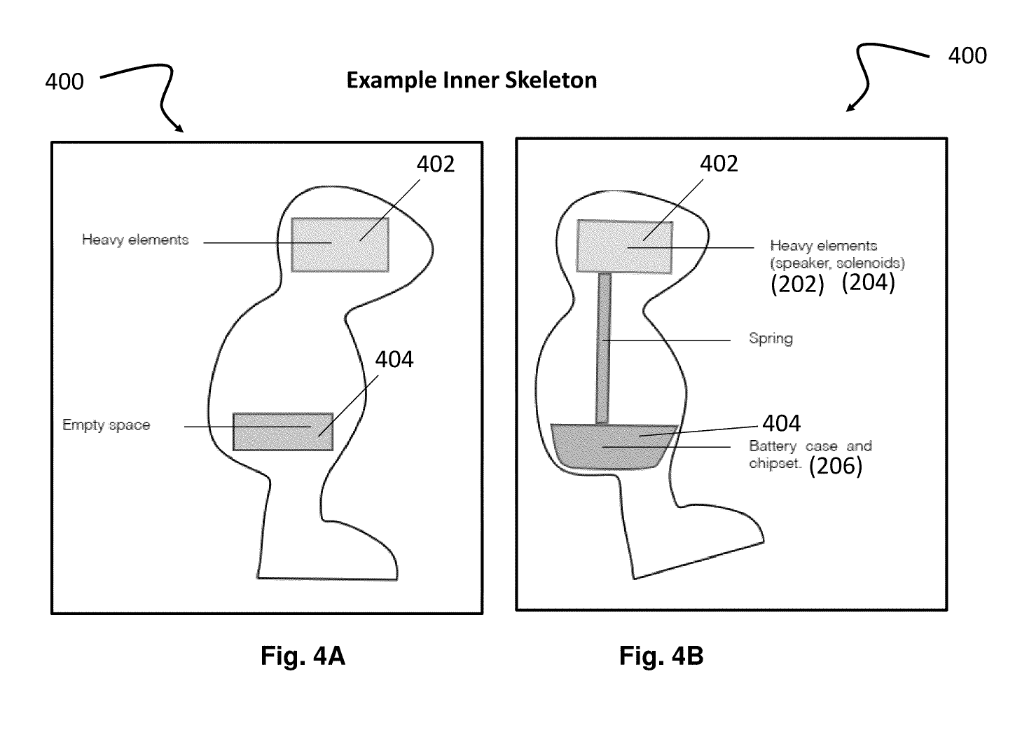

FIGS. 4A-4B are simple diagrams illustrating inner skeleton 400 that include elements in the head and the absence of other mechanisms that could compensate any imbalance near or at the center of gravity. The system is created, for example, for the backbone support and weighting of the pelvic part of the toy to provide the stable sitting position. In the lower part of the model, the battery case, the chipset 208 and the weighting substance 404 are provided and that will shift the center of gravity downwards. For the body of the model and to keep its shape, while remaining flexible, a spring 206 can be used as or with a backbone.

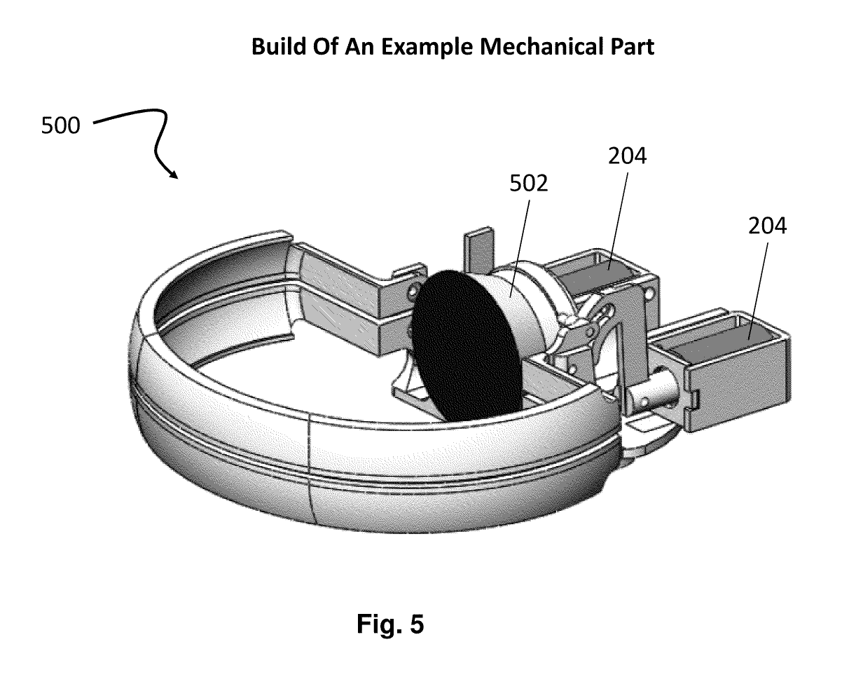

FIG. 5 is a diagram illustrating an mechanical part in accordance with an example head assembly 500 that includes magnetic elements (e.g., solenoids) 204 that are placed horizontally in the head. In addition, actuator portion 502 is provided that is usable to provide a movable jaw to simulate speech, singing, eating or other mouth movement. Actuator portion 502 can include an output driver (e.g., a speaker) to emanate sounds therefrom.

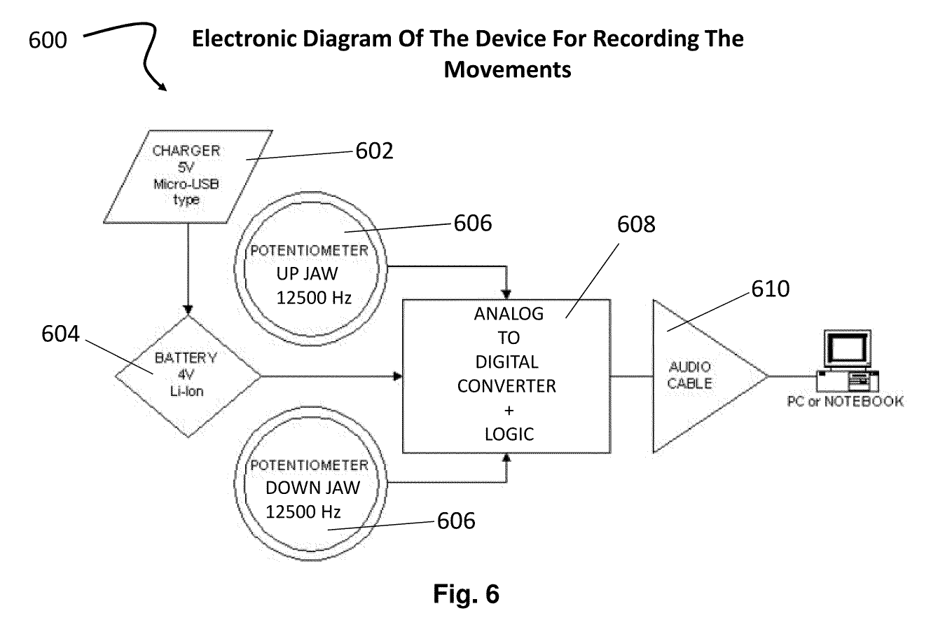

FIG. 6 is an example diagram 600 for recording movements in accordance with an example implementation of the present application. As illustrated in FIG. 6, charger 602, which can be a micro-USB type charger, can operate to charge battery 604, which can be a 4V lithium ion, and providing current to one or more components, such as an analog to digital converter, microprocessor and/or integrated circuits. In the example shown in FIG. 6, a jaw component actuates in response to a frequency of 12500 Hz. A cable 610 can next to a computing device, for recording the respective movement.

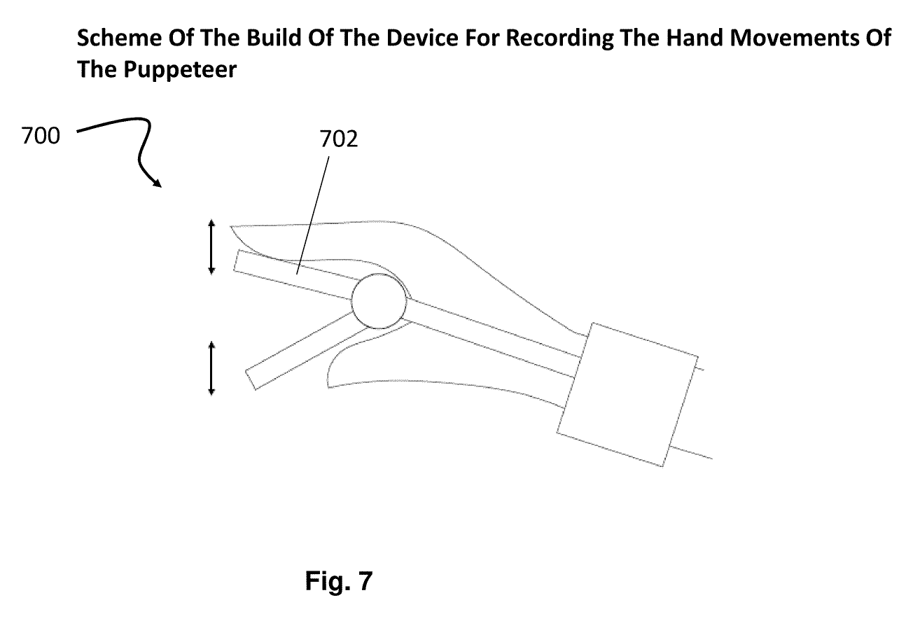

FIG. 7 is a diagram illustrating a scheme 700 for recording hand movements of a puppeteer in connection with the model set forth in an example implementation. For example, actuator 702 is shown that receives movement from the puppeteer and translates the movements into signals for recording purposes.

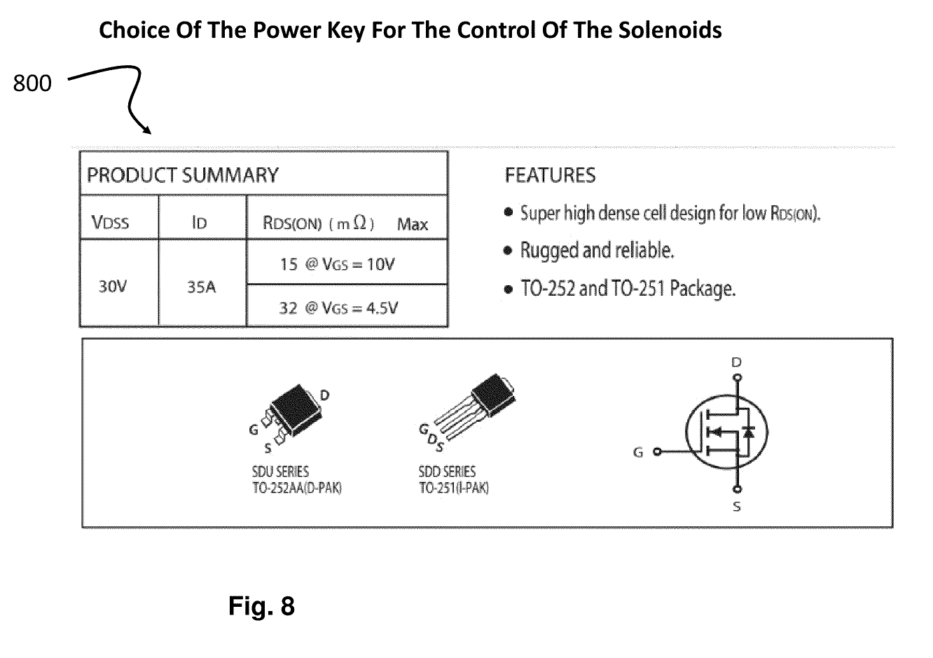

FIG. 8 is a diagram illustrating example power choices 800 for control of the solenoids 204 in connection with an example implementation.

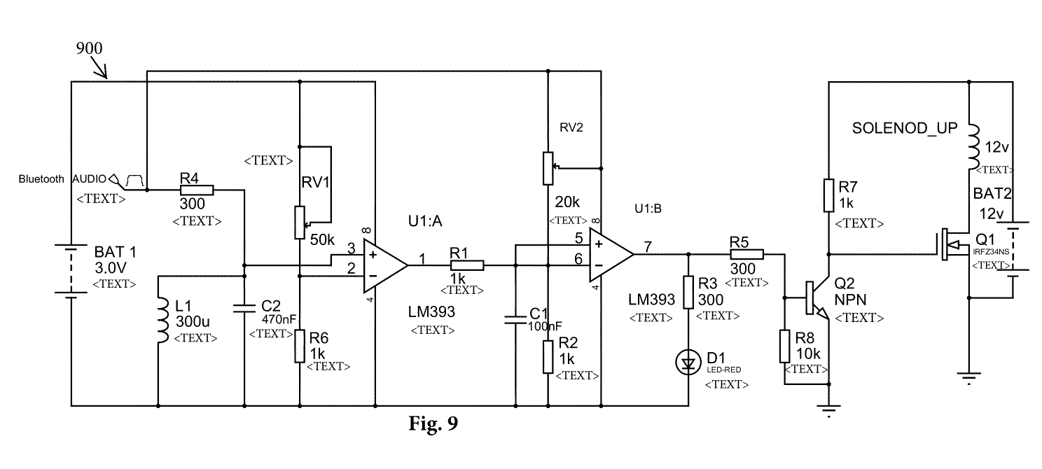

FIG. 9 is an example schematic 900 of a circuit board for detecting data clusters in a general channel and for identifying data type for transfer.

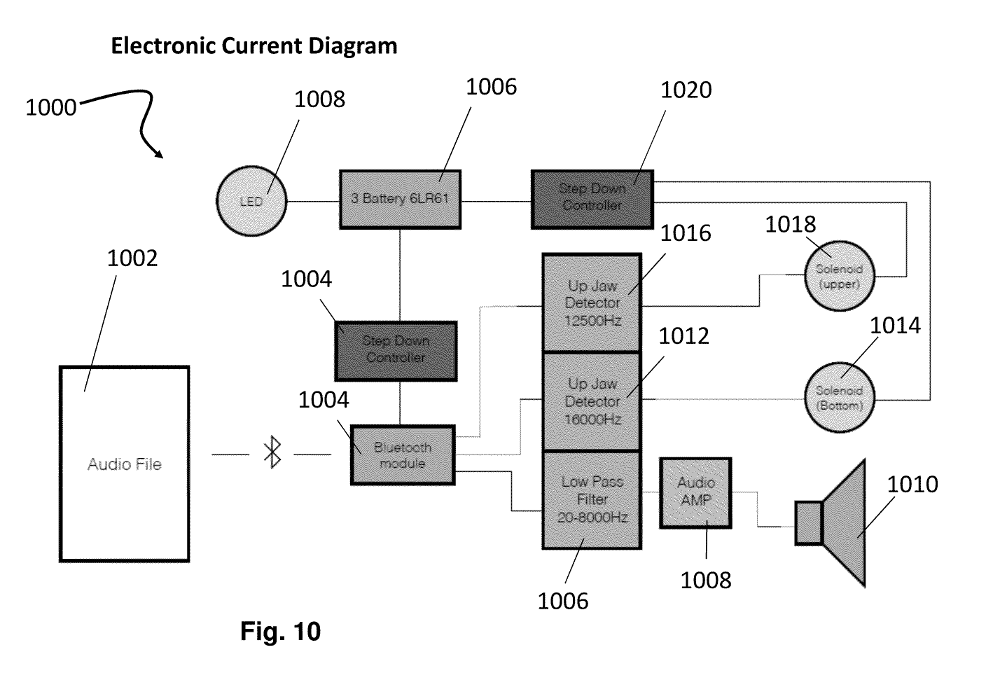

FIG. 10 is an electronic diagram 1000 that illustrates a components in a model, in connection with an example implementation. In the example shown in FIG. 10, Audio File 1002 is received and played via Bluetooth module 1004. A low-pass filter 1006 filters for frequencies between 20-8000 Hz for pass-thru to an audio amplifier 1008 for playback through speaker 1010. Frequencies at 16000 Hz are detected by component 1012 and result in actuation of (bottom) solenoid 1014. Similarly, frequencies at 125000 Hz are detected and result in actuation of (upper) solenoid 1018. Further, stepdown controller 1020 is usable for providing suitable voltage, for example, to/from battery 1006 and/or for LED 1008. In this way, frequencies can be detected and causing the model's jaw to move, and the respective audio file 1024 can play in response.

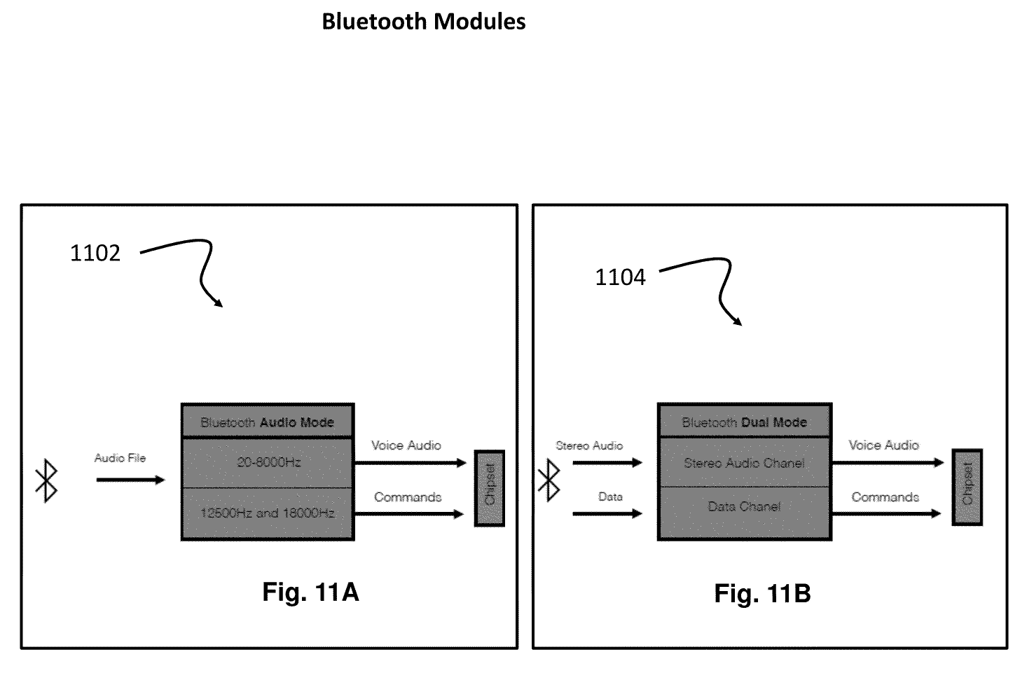

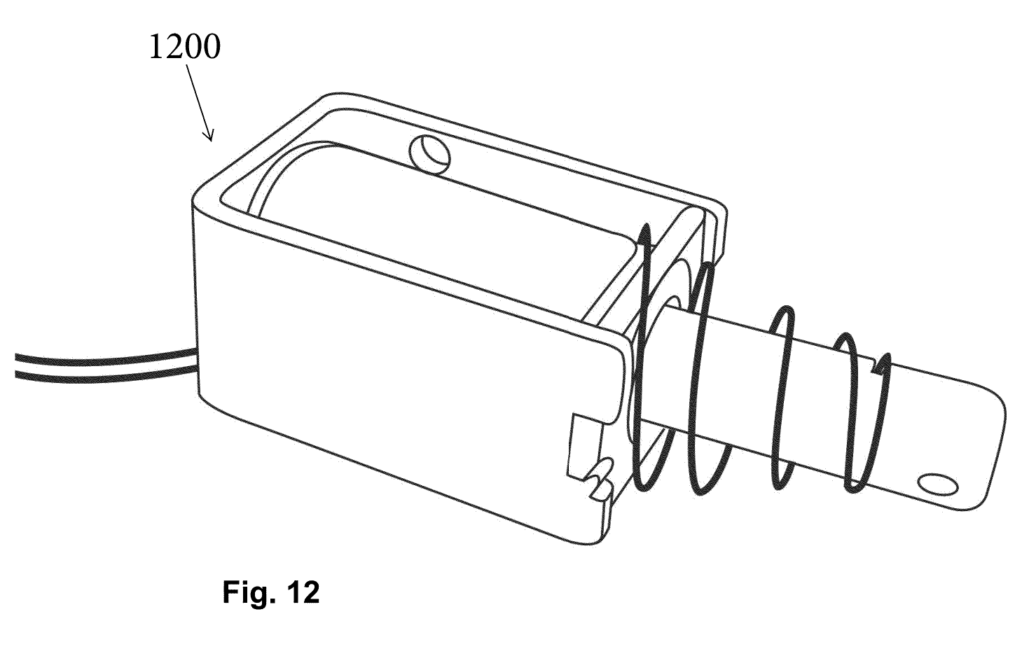

FIGS. 11A-11B are diagrams illustrating example Bluetooth modules in accordance with implementations of the present application. The implementation 1102 shown in FIG. 11A provides data transfer and audio output in a headset mode, using a different frequency. The implementation 1102 is relatively inexpensive, with some limitation in file transfer operability. The implementation 1104 shown in FIG. 11B is more expensive than implementation 1102, but carries an advantage with transmission operability for audio and data simultaneously.

FIG. 12 is a diagram illustrating an example solenoid 1200, which is a 12V, 500 mA type HCNE1-1039 solenoid, with a weight of 0.08 kg, 10 mm stroke and 25N gravitation.

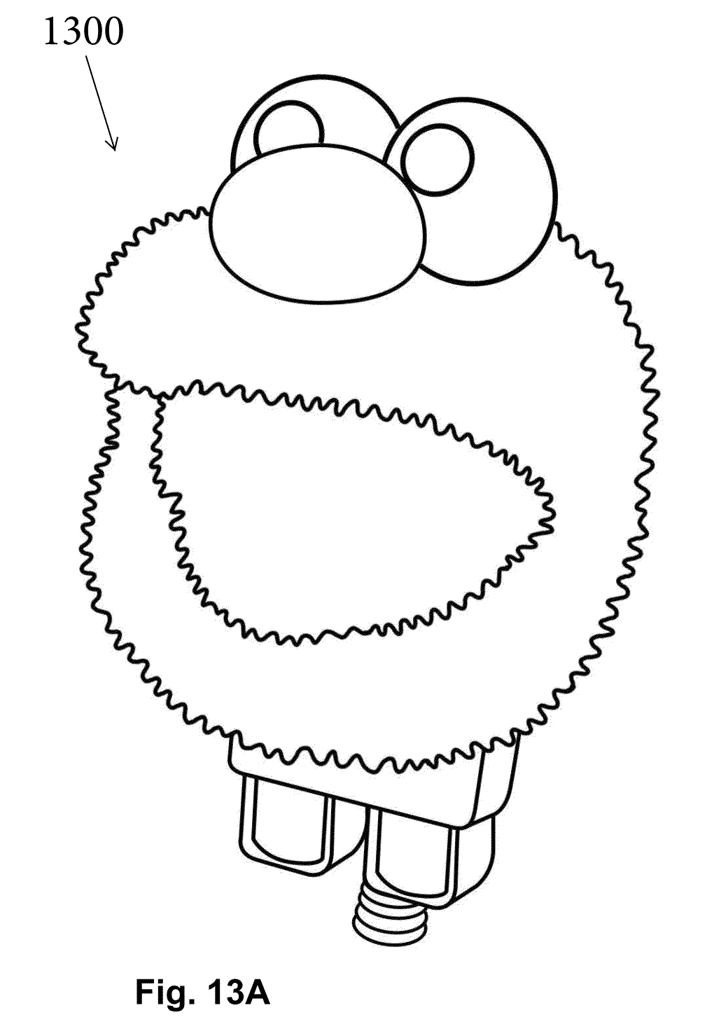

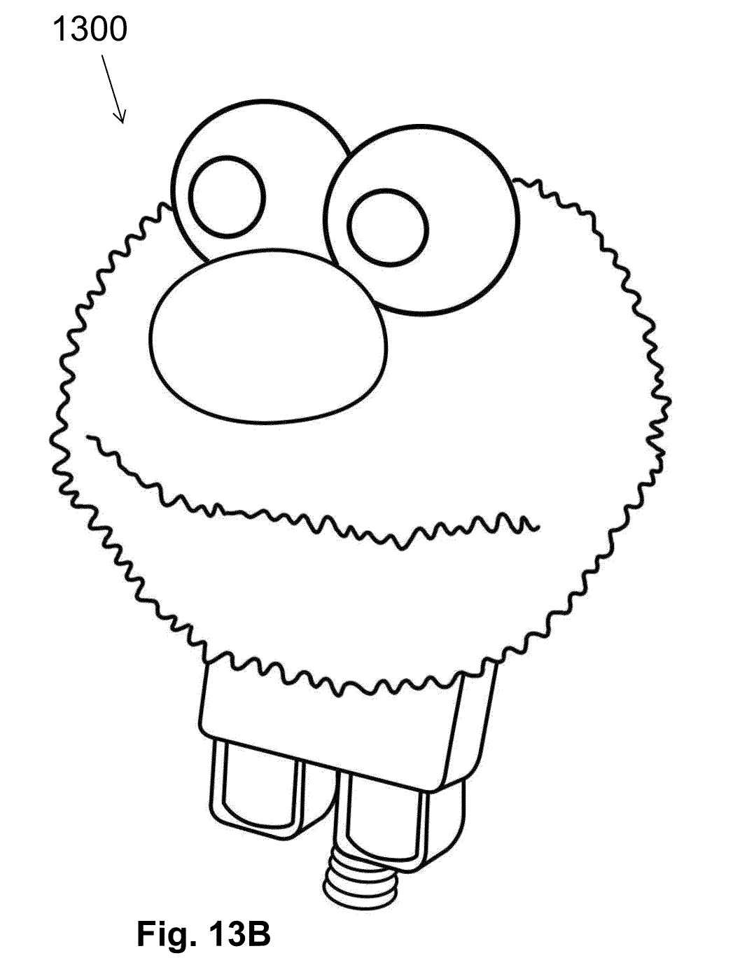

FIGS. 13A and 13B are diagrams illustrating an example model 1300 in various states. In FIG. 13A, the model 1300 is in a first state, and its mouth is open. In FIG. 13B, the model 1300 is shown having responded to a respective audio frequency and its mouth is closed. When the same frequency is detected again or, alternatively, a different frequency is detected, the mouth actuates again and the state of the model changes.

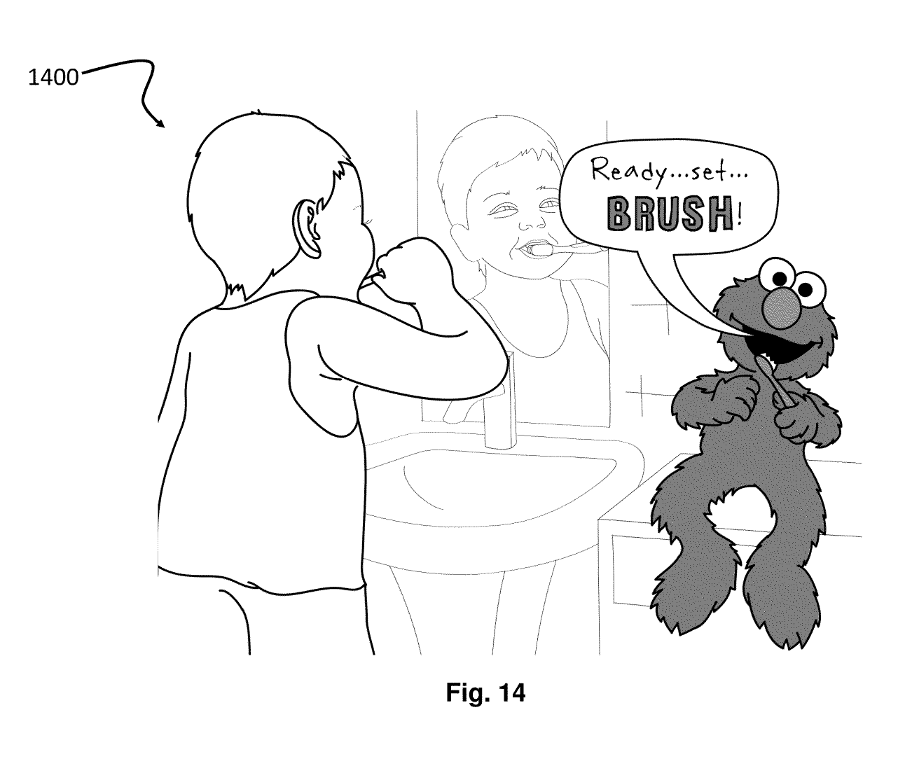

FIG. 14 is a diagram illustrating an implementation 1400 in which a model is a responsive to audio and social/developmental assistance with a child to brush teeth. The model in application 1400 is useful to reinforce good hygiene habits based on both a user's life-stage and external content (e.g., the time of day). In FIG. 14, the model is implemented as a child's toy, and is programmed to deliver appropriate hygiene educational content.

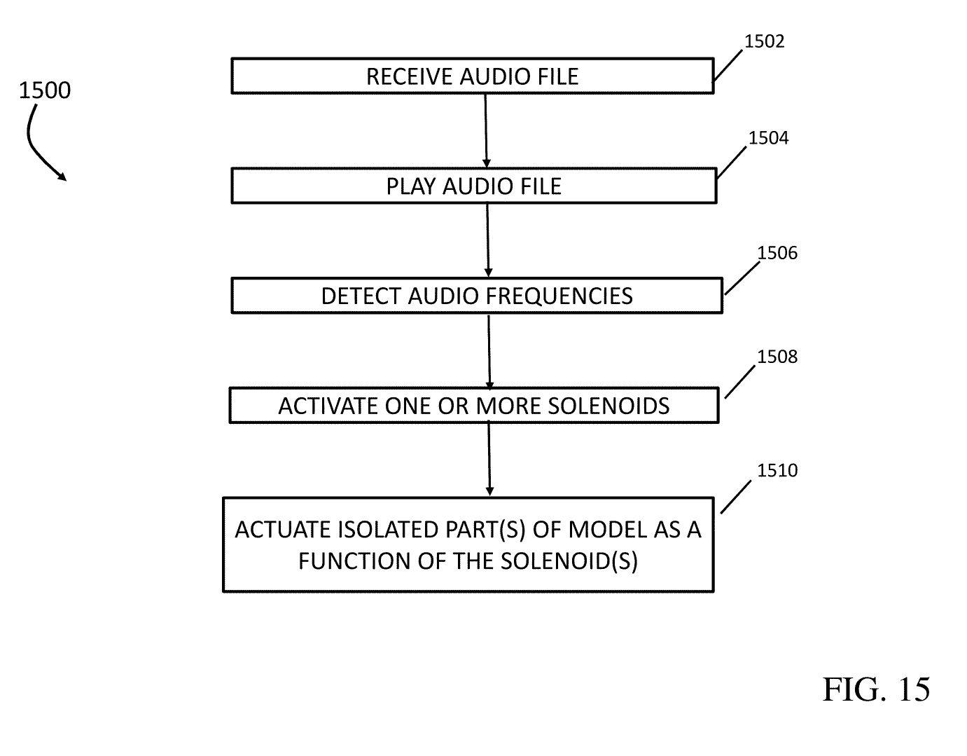

Turning now to FIG. 15, a flow diagram is described showing a routine 1500 that illustrates a broad aspect of a method for processing code(s) in accordance with at least one embodiment disclosed herein. Several of the logical operations described herein are implemented (1) as a sequence of computer implemented acts or program modules running on computing device and/or (2) as interconnected machine logic circuits or circuit modules within one or more computing devices. The implementation is a matter of choice dependent on the requirements of the device (e.g., size, energy, consumption, performance, etc.). Accordingly, the logical operations described herein are referred to variously as operations, steps, structural devices, acts, or modules. Various of these operations, steps, structural devices, acts and modules can be implemented in software, in firmware, in special purpose digital logic, and any combination thereof. Furthermore, more or fewer operations can be performed than shown in the figures and described herein. These operations can also be performed in a different order than those described herein.

Continuing with reference to FIG. 15, as noted herein and in at least one implementation, an audio file is received at step 1502. For example, the audio file is received by the model over a Bluetooth connection. Thereafter, the audio file is played (step 1504). Audio frequencies are detected (step 1506), and one or more solenoids configured with the model are activated in response to at least one respective frequency (e.g., 18000 Hz) being detected (step 1508). Thereafter, one or more isolated parts of the model actuate as a function of the at least one solenoid (step 1510).

Thus, as shown and described herein, kinetic information can be encoded in audio, such as a sound file, and a low-cost interactive model responds accordingly. When an analog frequency is recognized, respective movable portions of the model respectively actuate.

In one or more implementations regarding an educational model, cognitive support is supported and designed to teach someone in various ways. In one non-limiting example, a child can be taught how to describe times of day; how to track time; and how to adopt time-appropriate habits. For example, a child can be taught how to put on shoes, brush teeth or the like. Further, the model can point to important clues and asks predictive questions, thereby supporting a child's development of reading strategies and reading comprehension, scaffolding the reading experience.

With regard to social-emotional support, the model can provide to someone a friend who can respond in a personalized, contextually appropriate way. This can provide, for example, a benefit to parents, such as by providing personalized greetings that convey the fact that the model can educate and support children in ways big and small. The model can provide for context relevant greetings, such as responding to a particular time of day. Further, the model can support child engagement and alleviate frustration by responding to the child and encouraging the child to read. Parents cannot always be there with their child when the child tries to read a book. The model can become a reassurance that the model is an “educational agent,” guiding their child through the reading experience in a personalized way. In other contexts, the model can provide pre-visit information to various places, such as to doctors, dentists, airports, new schools, or virtually any other place that a user would appreciate advanced knowledge.

Although illustrated embodiments of the present invention have been shown and described, it should be understood that various changes, substitutions, and alterations can be made by one of ordinary skill in the art without departing from the scope of the present invention.

What is claimed is:

1. An interactive apparatus for providing actuations in at least one point of the apparatus, the apparatus comprising:
a base portion and an object portion;
an audio player component that is configured to receive and play an audio file having a plurality of frequencies;
an audio detection component that is configured to detect at least one frequency as the audio file plays; and
at least one solenoid component that is configured to actuate at least one point in the object portion in response to the at least one audio detection component detecting the at least one frequency.

2. The interactive apparatus of claim 1, wherein the audio player includes a wireless speaker and the audio detection component includes a wireless microphone.

3. The interactive apparatus of claim 1, wherein the audio player is configured with Bluetooth connectivity, and the audio file is received over a Bluetooth connection from a mobile computing device.

4. The interactive apparatus of claim 1, further comprising a processor and memory configured to receive, wherein the apparatus is configured using the processor and memory to receive and store instructions for causing respective actuations in response to respective frequency detection.

5. The interactive apparatus of claim 4, further comprising at least one passive radio-identification detector, wherein the apparatus is configured using the at least one passive radio-identification detector to detect an object configured with a passive radio-identification tag.

6. The interactive apparatus of claim 5, wherein the apparatus is further configured using the processor and memory to actuate in respective points in response to detection of at passive radio-identification tag.

7. The interactive apparatus of claim 4, further comprising a communications module that configures the apparatus to receive information using the communications module from at least one computing device.

8. The interactive apparatus of claim 7, wherein the communications module supports Wi-Fi connectivity.

9. The interactive apparatus of claim 1, wherein the apparatus is configured as a toy, and wherein the at least one point includes the toy' s mouth.

10. The interactive apparatus of claim 1, wherein the apparatus is configured to detect audio from a user and respond by playing an audio file and actuate at the at least one point.

11. A method for providing interactive actuations in at least one point of an apparatus that has a base portion and an object portion, the method comprising:
receiving and playing an audio file having a plurality of frequencies by an audio player component that is configured with the apparatus;
detecting, by an audio detection component provided with the apparatus, at least one frequency as the audio file plays; and
actuating, by at least one solenoid component, at least one point in the object portion in response to the at least one audio detection component detecting the at least one frequency.

12. The method of claim 11, wherein the audio player includes a wireless speaker and the audio detection component includes a wireless microphone.

13. The method of claim 11, wherein the audio player is configured with Bluetooth connectivity, and the audio file is received over a Bluetooth connection from a mobile computing device.

14. The method of claim 11, further comprising:
receiving and storing, with a processor and memory configured with the apparatus, instructions for causing respective actuations in response to respective frequency detection.

15. The method of claim 14, further comprising
detecting, with at least one passive radio-identification detector configured with the apparatus, an object configured with a passive radio-identification tag.

16. The method of claim 15, wherein the apparatus is further configured using the processor and memory to actuate in respective points in response to detection of at passive radio-identification tag.

17. The method of claim 14, further comprising:
receiving, via a communications module configured with the apparatus, information using the communications module from at least one computing device.

18. The method of claim 17, wherein the communications module supports Wi-Fi connectivity.

19. The method of claim 11, wherein the apparatus is configured as a toy, and wherein the at least one point includes the toy's mouth.

20. The method of claim 11, wherein the apparatus is configured to detect audio from a user and respond by playing an audio file and actuate at the at least one point.
